(19) United States
(12) Patent Application Publication
(10) Pub. No.: US 2013/0081613 A1
(43) Pub. Date: Apr. 4, 2013

(54) PROCESS FOR MANUFACTURING TAGATOSE AND GLUCOSE

(71) Applicant: Yijun Xu, Jiangsu (CN)

(72) Inventor: Yijun Xu, Jiangsu (CN)

(73) Assignee: WUXI JCANTEK PHARMACEUTICALS LIMITED, WUXI (CN)

(21) Appl. No.: 13/701,046

(22) PCT Filed: Jun. 2, 2010
(86) PCT No.: PCT/CN2010/073451

§ 371 Date: Nov. 30, 2012

(51) Int. Cl. C08B 37/00

(52) U.S. Cl. CPC C08B 37/00
USPC 127/36

(57) ABSTRACT

An economically feasible process for manufacturing tagatose is provided. The process includes hydrolyzing lactose to galactose and glucose, separating galatose from hydrolysates, and isomerizing galactose to tagatose with metal hydroxide in an aqueous suspension.

### CROSS-REFERENCE TO RELATED APPLICATIONS

This application claims priority to International Application Serial No. PCT/CH2010/073451 filed Jun. 2, 2010, which is hereby incorporated herein for all purposes by this reference.

### FIELD OF THE INVENTION

The present invention relates to an economically feasible process for manufacturing tagatose and glucose from lactose.

### BACKGROUND OF THE INVENTION

D-Tagatose (tagatose, D-xylo-hexulose) is a rare naturally occurring hexoketose monosaccharide. Tagatose differs from D-glucose (glucose) and D-galactose (galactose) and D-fructose (fructose) in intramolecule atomic arrangement despite the same hexose formula C₆H₁₂O₆ (MW=180.16). Tagatose is a stereoisomer of fructose found in dairy products, some fruits and grains at concentrations between 2 to 800 ppm.

Tagatose is an odorless white crystalline solid. It is very similar in texture to sucrose, with 92% sweetness, but only 38% of the calories. Tagatose provides very fresh and sharp sweetness, and its quality of taste is similar to fructose. Tagatose has been found to be safe and efficacious for use as a low-calorie, full-bulk natural sugar in a wide variety of foods, beverages, health foods and dietary supplements. Its synergism with high-intensity sweeteners also makes it useful in sodas.

Tagatose is generally recognized as safe (GRAS) by the United States and the FAO/WHO since 2001. FDA approved tagatose as a tooth friendly ingredient in December 2002, and a food additive in October 2003. The Joint FAO/WHO Expert Committee on Food Additives (JECFA) states there is no need to limit the allowable daily intake (ADI) of tagatose, and allocates an ADI of “not specified”, the safest category in which JECFA can place a food ingredient at its 63^{rd} meeting in 2004. On December 2005, tagatose was formally approved as a novel food ingredient in the European Union without any restriction on usages. All regulatory hurdles have now been cleared for the beneficial food and beverage uses of this simple, naturally occurring sugar.

Various health and medical benefits are evident for tagatose for its drug and nondrug as well as nonfood uses, including the treatment of Type II diabetes, hyperglycemia, anemia, hemophilia, organ transplants, weight loss, the improvement of fetal development, and in nonchronic drugs. Tagatose has been studied as a potential antidiabetic and antiobesity as well as antihyperglycemic medication. Tagatose can be used as an intermediate for the synthesis of optically active compounds, and as an additive in toothpaste, detergent, cosmetic and pharmaceutical formulations. Tagatose is non-cariogenic and reduces insulin demand.

Tagatose is generally prepared by the isomerization of galactose at C-2 by chemical (alkaline) catalysts using alkaline-earth or rare-earth metal ions under alkaline condition, or biological (enzymatic) biocatalysts using several L-arabinose isomerases.

The economical production of tagatose requires a ready source of galactose.

Galactose is not usually found free in nature, but exists with glucose in the disaccharide lactose via a β1→4 glycosidic linkage or with repeating galactose units as a polymeric galactan in hemicellulose in a variety of plant seed and timber.

Production of tagatose using commercial galactose is economically infeasible in view of the cost approximately US $90 per kilogram.

The best source of galactose is commercial lactose, a plentiful, inexpensive byproduct obtained from whey of milk, chemically known as a-lactose monohydrate. The price of lactose varies from US $0.22 to 0.66 per kilogram over recent decades. At least 4 million tons of lactose per annum is recovered from whey in the cheese processing industry worldwide.

Hydrolysis of the lactose 1-4 linkage by the action of enzyme lactase (β-galactosidase), or by the action of acid under heating condition, results in the formation of an equimolar mixture of the monosaccharide galactose and glucose.

The hydrolysis process of lactose by the action of acid is shown as follows:

The hydrolysis process of lactose by the action of β-galactosidase is shown as follows:

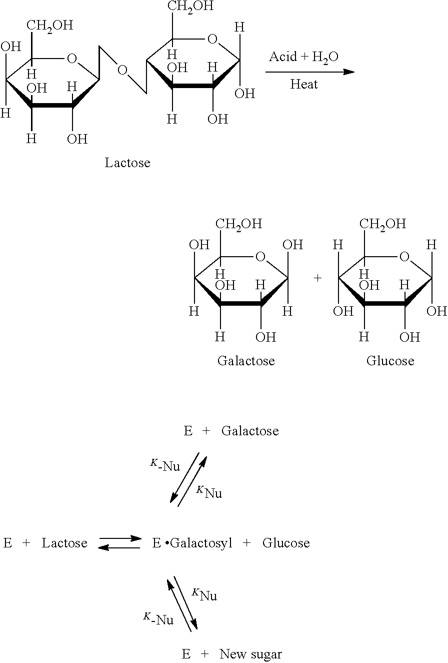

E represents the β-galactosidases, E.Galactosyl represents the enzyme-galactosyl complex, K represents the reaction rate constant, and Nu (nucleophile) represents an acceptor containing a hydroxyl group. As shown in the diagram, the first step is the enzyme-galactosyl complex formation and simultaneous glucose liberation, and the second step is to transfer the enzyme-galactosyl complex to an acceptor containing a hydroxyl group. Water and sugar molecules in the solution can be the Nu to accept galactosyl moiety from the enzyme-galactosyl complex resulting in the formation of galactose and new sugar e.g. trisaccharides (β-D-galactose-(1→6)-lactose). While in a low lactose content solution, water rather than other sugars such as glucose and lactose can be more competitive as an acceptor, therefore, galactose is formed and released from the active site. On the other hand, in a high lactose content solution, lactose molecules have higher chances to act as the acceptor, binding with the enzyme-galactosyl complex to form trisaccharides. It is known that enzymatic hydrolysis of lactose in a high initial substrate concentration results in a high concentration of trisaccharides.

The economical production of tagatose from lactose requires an economically feasible manufacturing process.

U.S. Pat. Nos. 5,002,612, 5,078,796, 6,057,135 and 6,991,923 described manufacture of tagatose with lactose derived from whey by a two-stage process involving enzymatic hydrolysis of lactose by soluble or immobilized lactase to yield galactose and glucose, and isomerization of galactose to tagatose under either alkaline or enzymatic conditions.

As discussed above, enzymatic hydrolysis of lactose is a complex process involving multiple sequential reactions with saccharides as intermediate products. Concentration of oligosaccharides other than the monosaccharides glucose and galactose are increased with the initial concentration of lactose by weight (Biotechnol Bioeng 30:1019, 1987; J Agric Food Chem 54:4999, 2006). U.S. Pat. No. 6,057,135 disclosed enzymatic hydrolyzates of 9% lactose consisted of 3% lactose, 48% galactose and 50% glucose after 8 hours hydrolysis. U.S. Pat. Nos. 5,002,612 and 5,078,796 described 6 hours hydrolyzates of 20% lactose consisted of 10% lactose, 45% galactose and 45% glucose. Another hydrolyzates of 25% lactose composed of 35% monosaccharides, 11% allolactose (β-D-galactose-(1→6)-D-glucose), 5% 6-galactobiose (β-D-galactose-(1→4)-D-galactose), 31% lactose and 16% 6′-galactosyl-lactose (β-D-galactose-(1→6)-lactose) (J Agric Food Chem 56:10954, 2008).

Alkaline isomerization of galactose to tagatose is achieved with several alkaline catalysts including a combination of calcium ion and monoamine (Carbohydr Res 333:303, 2001), sodium aluminate (Carbohydr Res 337:779, 2002), and metal hydroxide such as calcium hydroxide (Process for manufacturing tagatose, U.S. Pat. No. 5,002,612, 1991; Process for manufacturing tagatose, U.S. Pat. No. 5,078,796, 1992), a process used to yield about 50% of tagatose at 10% by weight galactose over 2-4 hours.

Enzymatic isomerization of galactose to tagatose is achieved with either soluble or immobilized L-arabinose isomerase (Process for manufacturing D-tagatose, U.S. Pat. No. 6,057,135, 2000; Process for manufacturing D-tagatose, U.S. Pat. No. 6,991,923, 2006), a process used to produce 32% of tagatose at 10% galactose over 72 hours and 38% at 14% galactose by weight over 24 hours. U.S. Patent Application No. 20090306366 described a tagatose productivity of 11.6 g/L·h based on converted 232 g/L tagatose from 300 g/L galactose with boric acid under optimum reaction for 20 h.

Although these processes can be used to produce pure galactose and glucose as well as tagatose from lactose, but are technically and economically infeasible because of unacceptable industrial costs. None of the foregoing literature references or patents disclose or suggest a technically and economically feasible process for manufacturing tagatose and glucose from lactose. No processes as yet seem to have reached full-scale commercial application.

In enzyme-catalyzed hydrolysis of lactose, p-galactosidases prefers to hydrolyze lactose at low initial concentration, the rate of hydrolysis tends to be rather slow, the hydrolysis is liable to be subjected to bacteriological contamination, galactose is a product but also a competitive inhibitor of the enzyme. Unsatisfied galactose and glucose yields and the formation of oligosaccharides lead to problems of off-unwanted byproducts from hydrolyzed lactose. The process presents the drawbacks of requiring very high reaction volume for obtaining small quantities of products, too expensive and does not appear economically feasible from the industrial aspect.

In alkaline-catalyzed isomerization of galactose, function of alkaline catalysts are two-fold: catalysis of the isomerization of glactose into tagatose and catalysis of the degradation of galactose into dicarbonyl compounds and acidic species. The process presents the drawbacks of producing a high level of galactose degradation leading to the decline in the tagatose yield, complicate the extraction steps necessary to eliminate the degraded products, impoverish the syrups quality and make more difficult the preparation of crystalline tagatose.

The process of alkaline-catalyzed isomerization of galactose can be shown as follows:

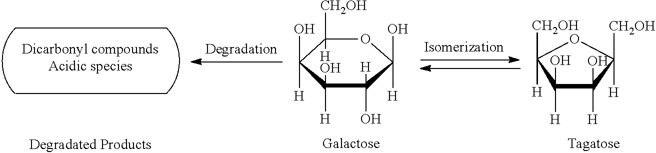

enzyme-catalyzed isomerization of galactose, the equilibrium between substrate and product is determined by L-arabinose isomerase, the rate of isomerization tends to be rather slow, separation of tagatose and unconverted galactose and recycling of unconverted galactose require complex purification and concentration steps. The process faces the same drawbacks of low productivity, making it too expensive and economically infeasible.

We assumed that the facility has a 16000 L vessel that can be utilized for the manufacture of tagatose and glucose from lactose. The hydrolysis would use 10000 L while the other 6000 L would be used for isomerization. According to the U.S. Pat. Nos. 5,002,612, 5,078,796 and 6,057,135, a facility using a 10000 L hydrolysis of 9% to 20% lactose should be able to produce 405 to 960 kg of galactose and 405 to 1000 kg of glucose per 6-8 h. According U.S. Pat. Nos. 5,002,612, 5,078,696, 6,057,135 and 6,991,923, a facility using a 6000 L alkaline isomerization of 10% galactose should be able to produce 300 kg of tagatose per 2-4 hours; and using a 6000 L enzymatic isomerization of 10 to 14% galactose should be able to produce 192 to 319 kg of tagatose per 24 to 72 h.

### SUMMARY OF THE INVENTION

An objective of the present invention is to provide a process for manufacturing tagatose from galactose with essentially avoided degradation of galactose, which comprises the step: c) reaction of an aqueous suspension of galactose under the presence of metal ions and alkaline condition to convert galactose into tagatose. Step c) hereinafter is referred to as isomerization step for discussing conveniently.

This process is commercially feasible and free from the above-mentioned drawbacks in the prior arts and thus it can be used for economically manufacturing tagatose from galactose.

Another objective of the invention is to provide a process which can hydrolyze lactose into galactose and glucose without side reactions.

Still another objective of the invention is to provide a process which can prevent the decomposition of galactose and glucose during chromatographic separation.

Still another objective of the present invention is to provide a process for manufacturing tagatose and glucose from lactose, which comprises the following steps: a) hydrolysis of lactose with mineral acid in an aqueous solution to convert lactose to galactose and glucose; b) separation of the galactose and glucose from hydrolyzate; c) reaction of an aqueous suspension of galactose under the presence of metal ions and alkaline condition to convert galactose into tagatose.

One feature of the invention is the finding that lactose can be hydrolyzed selectively into galactose and glucose without byproducts by using mineral acid under heating.

The acid hydrolysis process offers the advantages in terms of increased initial lactose concentration to more than 30% by weight and shortened reaction time of hydrolysis to 2 hours, and therefore can hydrolysis lactose effectively and economically for mass production of galactose and glucose, the valuable intermediate and products of the invention.

Another feature of the invention is the finding that water is an important stabilizer for galactose and glucose at elevated temperature and pressure as well as eluent conditions typically used within chromatographic separation and detection.

Water used as eluent also offers the advantages in terms of increased effectiveness of chromatographic separation and reduced costs through preventing decomposition of galactose and glucose and removing expensive organic solvent from elution profile.

Another feature of the invention is the finding that galactose can be isomerized into tagatose by essentially voiding degradation by reacting in suspension and using metal hydroxide as catalyst.

The alkaline isomerization process offers the advantages in terms of increased initial galactose concentration to more than 30% by weight and shortened reaction time of isomerization to 2 hours, and therefore can isomerize galactose effectively and economically for mass production of tagatose, the valuable product of the invention.

In particular, the present invention provides an economically feasible process for mass production of tagatose and glucose from lactose for full-scale commercial application. A facility using a 10000 L hydrolysis should be able to produce 3000 kg of galactose and 3000 kg of glucose per 2 hours, and using a 6000 L isomerization should be able to produce 3000 kg of tagatose per 2 hours.

### BRIEF DESCRIPTION OF DRAWINGS

FIG. 1 is a graph showing the conversion of lactose and the formation of galactose and glucose over the course of acid-catalyzed hydrolysis of lactose.

FIG. 2a is a HPLC chromatogram showing the reference standard mixture containing lactose, glucose, galactose and tagatose.

FIG. 2b is a HPLC chromatogram showing the product tagatose manufactured according to the present invention.

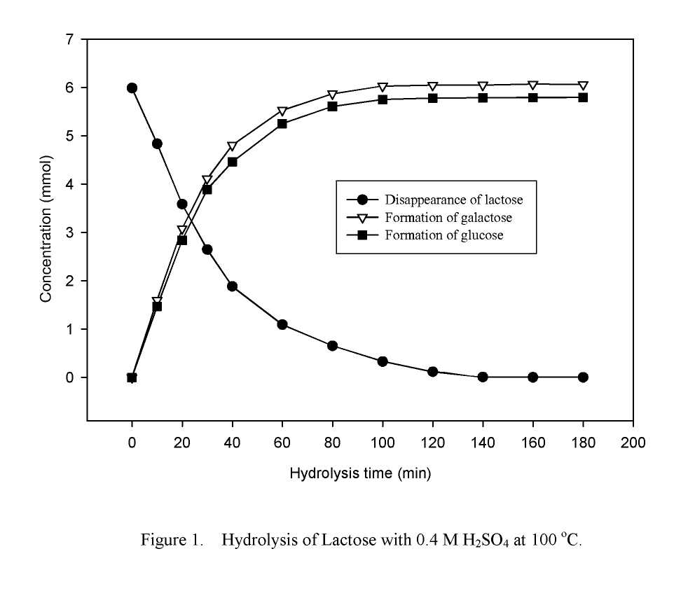

### DETAILED DESCRIPTION OF THE INVENTION

In an embodiment of the present invention, manufacture of tagatose and glucose from lactose comprises a three-step process including the hydrolysis of lactose, the separation of galactose and glucose, as well as the isomerization of galactose.

In the hydrolysis step of this process, a particular hydrolysis procedure is established in ensuring to achieve the effectiveness and the general economic feasibility of the hydrolysis. Procedure that uses mineral acid as the hydrolytic catalyst according to the invention is a milder chemical hydrolysis for lactose. It is able to split lactose into to galactose and glucose without byproducts because of the complete and nondestructive characters of the hydrolysis. An additional benefit of using acidic hydrolysis is the reaction may be carried out under higher temperature where the solubility of lactose is higher. This means that more concentrated lactose can be applied in the hydrolysis of the invention. This again means a less acid consumption and a short reaction time for hydrolysis. The acid-catalyzed hydrolysis of this invention minimizes hydrolysis costs and maximizes hydrolysis yields per time unit.

The mineral acid usable in the present invention is preferable to be one or more selected from the group consisting of carbonic acid, hydrochloric acid, phosphoric acid and sulfuric acid, and more preferably sulfuric acid.

The hydrolysis step is preferable to perform with 0.2-0.6 M mineral acid and perform under temperature between 90-120° C.

By following the above procedure, it is assured to obtain a high conversion (95-100%) of lactose with a high yield (95-100%) of galactose and glucose.

With this procedure, hydrolysis of lactose yields an equimolar mixture of the galactose and glucose. The obtained hydrolysate is cooled, neutralized and demineralized according to known techniques in the art.

Subsequently, the equimolar mixture of the galactose and glucose are separated into the products of galactose and glucose respectively by any known separation technologies in the art preferably with high performance liquid chromatography (HPLC).

In the chromatographic separation step of this invention, a particular elution profile is established in ensuring to prevent the decomposition of galactose and glucose during HPLC separation.

Addition of 10.0% acetonitrile in water instead of water as eluent has significantly reduced the detection of both galactose and glucose as temperature rises when using a Ca²⁺-form carbohydrate column (Table 1).

TABLE 1
Function of Elution Profile on Chromatogram Peak Area

| | Elution Profile (v:v) | | | |
|---|---|---|---|---|
| Column | | Acetonitrile | Chromatogram Peak Area | |
| Temperature | Water (H₂O) | (CH₃CN) | Galactose | Glucose |
| 65° C. | 100 | 0 | 182016 | 166739 |
| | 90 | 10 | 184450 | 164938 |
| 75° C. | 100 | 0 | 182783 | 171939 |
| | 90 | 10 | 149074 | 158741 |
| 85° C. | 100 | 0 | 183709 | 172437 |
| | 90 | 10 | 120506 | 149855 |

Removal of water from the start solvent gradient from the combination with acetonitrile has significantly reduced the detection of galactose and glucose when using an amino-bonded silica carbohydrate column.

The rate of decomposition of galactose and glucose is a result of elevated temperature and pressure.

It is surprisingly found that water is the most effective solvent and stabilizer in the chromatographic separation of galactose and glucose under the HPLC conditions. Following separation, the separated galactose and glucose solution are evaporated and then crystallized or dried into galactose and glucose crystals or powders, respectively.

The obtained glucose can be sold or processed further into a salable product such as high fructose corn syrup.

Developing the value of glucose can help lower overall production costs.

In the isomerization step of this process, a particular alkaline isomerization procedure is established in ensuring to reach the effectiveness and the general economic feasibility of the isomerization.

Galactose in general undergoes both reversible and irreversible reactions in alkaline aqueous solution with metal ions. The reversible reactions mainly include isomerization of galactose into tagatose. The irreversible reactions mainly include non-oxidative alkaline degradation and oxidative alkaline degradation of galactose into dicarbonyl compounds and acidic species. Therefore, a complete isomerization of one monosaccharide galactose into another monosaccharide tagatose may be impossible under these conditions.

Alkaline isomerization and alkaline degradation of galactose are two synchronous processes observed in the alkaline solution with metal ions. The process of alkaline isomerization of galactose is independent from the process of alkaline degradation of galactose. The isomerization of galactose into tagatose is faster than the degradation of galactose into dicarbonyl compounds and acidic species. Maximum production of tagatose is nearly completed within the first 0.5 hour, whereas degradation of galactose reaches the high value in the second hour of the reaction, respectively (see Table 2).

TABLE 2
Relationship of alkaline isomerization
and alkaline degradation of galactose.

| | |
|---|---|
| Reaction | Converted Galactose (%) |

| Time | Unconverted | | Degradated |
|---|---|---|---|
| (Hour) | Galactose (%) | Tagatose | Products |
| 0 | 100.0 | 0 | 0 |
| 0.5 | 15.4 | 54.9 | 29.7 |
| 1 | 7.9 | 55.2 | 36.9 |
| 1.5 | 4.0 | 54.6 | 41.4 |
| 2 | 1.1 | 55.8 | 43.1 |
| 3 | 0 | 53.7 | 47.3 |
| 4 | 0 | 54.6 | 45.4 |
| 5 | 0 | 53.5 | 46.5 |
| 30 | 0 | 21.5 | 78.5 |

The initial galactose concentration was 18% by weight in deionized water. The concentration of calcium hydroxide as alkaline reagent was 8% by weight in deionized water.

The rate of alkaline isomerization of galactose is dependent on the rate of alkaline degradation of galactose.

It is surprisingly found that galactose undergoes the isomerization while essentially avoiding degradation in alkaline aqueous suspension with metal ions. The equilibrium between the substrate of galactose and the products of tagatose and degradated products are altered toward tagatose while the reaction is performed in the alkaline suspension. As a result, the yield of tagatose formed in the isomerization becomes the highest via prevention of the concurrent degradation in alkaline suspension of galactose.

The isomerization step c) is preferable to be carried out by reaction of an aqueous suspension of galactose with sodium afuminate and metal hydroxide or the mixture thereof. The metal hydroxide preferably is one or more selected from the group consisting of aluminum hydroxide, barium hydroxide, calcium hydroxide, magnesium hydroxide, and strontium hydroxide, more preferably calcium hydroxide.

The isomerization step is preferably performed with a molar ratio for metal hydroxide:galactose of 0.5:1-2:1. The isomerization step is preferably performed at 0-30° C.

The isomerization of galactose is preferable to be carried out by adding an aqueous slurry of metal hydroxide into a suspension of galactose.

The term “slurry of metal hydroxide” in the present application refers to an aqueous suspension that contains metal hydroxide more than that could be dissolved in the water under stirring.

The slurry of metal hydroxide in the present application may be prepared by any technology known in the art, such as by adding metal hydroxide into water under stirring.

The slurry of metal hydroxide is preferably to be a slurry of calcium hydroxide in water.

The term “suspension of galactose” in the present application refers to a solution that contains galactose more than that could be dissolved in the solvent. The excessive galactose contained in the solvent stays as insoluble solutes homogenously distributed throughout the liquid under stirring.

Preferably, the solvent is water.

The suspension of galactose in the present application preferably has a galactose content of more than 30% by weight in water, more preferably 50-70% by weight.

The solubility of galactose varies depending on the adopted reacting conditions such as temperature and pressure etc., and thus the amount of galactose added in the suspension of galactose may also vary accordingly.

The suspension of galactose in the present application may be prepared according to any known technology in the art, for example by mixing the galactose with water under stirring.

The overall production costs is further lowered by preventing the alkaline degradation of galactose.

The following is a description of the preferred embodiment of the isomerization step of this process which comprises preparing an aqueous suspension of galactose with a galactose content of more than 50% and less than 70% by weight, said suspension is maintained at a temperature of 0-30° C., and preferably 5-15° C.; preparing an aqueous slurry of Ca(OH)₂ (preferably >24% by weight) by adding Ca(OH)₂ to water or by adding calcium oxide (CaO) (preferably >18% by weight) to water, said slurry is maintained at a temperature of 0-30° C., and preferably 5-15° C.; introducing the Ca(OH)₂ slurry into the suspension of galactose under stirring for 2 hours while maintaining this temperature; stopping the reaction by neutralizing the reaction mixture with most common mineral acids such as hydrochloric acid, phosphoric acid, sulfuric acid and preferably carbonic acid that frees the tagatose from intermediate calcium hydroxide-tagatose complex and forms a poorly soluble calcium salt; removing the salts by a combination of filtration and ion exchange; and recovering the pure tagatose by concentrating the solution and thus crystallizing the obtained product.

In the neutralization step, the temperature is preferably to be kept within 0-20° C. as long as the pH value is still relatively alkaline. Once the pH approaches neutral, the cooling and the introduction of mineral acid are discontinued.

The process of the invention is distinguished particularly by its extraordinary economy. It can be performed without expensive apparatus. Due to its economy, it is particularly well suited for the production of tagatose and glucose on a large commercial scale, and in this it is very much superior to the manufacturing processes known hitherto. The economical production and highest yield of tagatose and glucose obtained in this invention are unprecedented.

The following Example illustrates the present invention, which shall not be considered as limitation to the present invention.

### EXAMPLES

### Example 1

### Hydrolysis of Lactose with Sulfuric Acid

Lactose (purity ≧99%) was produced from whey by ultrafiltration followed by crystallization. 10 L 36% lactose in 0.4 M sulfuric acid (wlv) was carried out with stirring at 100° C. The progress of the hydrolysis was monitored by HPLC each 0.5 hour, as described below. After 2 hours lactose was completely hydrolyzed into its subunits galactose and glucose. The hydrolyzate was found to contain 1764 g galactose, and 1728 g glucose based on 3600 g lactose added, showing a 99% conversion of lactose, and a yield of 49% galactose and a yield of 48% glucose.

### Method of Assay

An aliquots of the reaction mixture was withdrawn from the reactor and diluted ten-fold with deionized water. The reaction mixture was neutralized and filtered through 0.2 μm filter. The detection was done by Waters HPLC using a Bio-Rad Aminex HPX-87 C column (Ca²⁺ form) and a Water 2414 differential refractometer. The eluent was deionized water with 0.005% calcium acetate (w/v). The column temperature was 85° C. and the flow rate was 0.6 ml per minute. The HPLC system was calibrated before use with a mixed standard sugars at a known concentration.

### Example 2

### Stability of Galactose and Glucose in Chromatographic Separation

Galactose, glucose and tagatose were obtained from Sigma (Reagent grade).

Comparable analyses were performed in the ligand-exchange mode on a Ca²⁺-form Aminex HPX-87C column using a Waters HPLC system with a Waters 2414 differential refractometer. The column temperature was 65° C., 75° C. and 85° C., and the eluent was water and 10% acetonitrile in water (v/v), respectively. The flow rate was 0.6 ml per min. All analytical samples were diluted with deionized water and filtered through a 0.2 μm filter prior to HPLC-analysis.

The results revealed a drop in the detection of both galactose and glucose as column temperature was elevated but no similar effect was detected on tagatose when using 10% acetonitrile in water as eluent. The column temperature effect was found to be more pronounced for galactose (34% reduction) than for glucose (13% reduction). The systematic decrease of both galactose and glucose was not observed when using water as eluent.

### Example 3

### Isomerization of Galactose in the Solution with Calcium Hydroxide

Calcium hydroxide slurry (37% by weight, 5M) was prepared by carefully mixing calcium oxide (CaO, called lime or quicklime) with deionized water and cooled to about 5 to 15° C. Galactose solution (18% by weight, 1M) was prepared by dissolving galactose in deionized water and cooled to about 5 to 15° C. At that temperature, 1 L of the calcium hydroxide slurry were gradually added into the 5 L of galactose solution under stirring and cooling, the temperature not being allowed to rise above 20° C. The progress of the reaction was monitored by HPLC analysis each 0.5 hour, as described in Example 1.

This resulted in the formation of a mass which gradually became jelly-like, becoming increasingly viscous upon one hour of standing in the cold state. After approximately 2 hours, galactose conversion reached greater than 95% and the reaction was terminated by slowly adding carbonic acid until the pH was below 7. As the gel dissolved, tagatose released and calcium carbonate precipitated in the reaction mixture. The calcium carbonate solids were separated from the reaction mixture by filter press.

The analysis of the solution showed that 900 g of galactose had been consumed and 486 g of tagatose had been produced with a conversion of 100% and a yield of 54.8%.

The filtrate containing tagatose was deionized through ion-exchange resins according to known procedures. The collected deionized filtrate was concentrated via evaporation to form a thick syrup. Tagatose was crystallized from the syrup by addition of ethanol and cooling in a freezer. Tagatose crystals were refined with 95% ethanol to obtain a composition of 99.1% tagatose and 0.9% unknown.

### Example 4

### Isomerization of Galactose in the Suspension with Calcium Hydroxide

Calcium hydroxide slurry (49% by weight, 6.67M) was prepared by carefully mixing calcium oxide with deionized water and cooled to about 5 to 15° C. Galactose suspension (55% by weight, 3.08M) was prepared by mixing galactose in deionized water and cooled to about 5 to 15° C. At that temperature, 2.2 L of the calcium hydroxide slurry were gradually added to the 5 L of galactose suspension under strong agitation and good cooling, the temperature was not allowed to rise above 20° C. The progress of the reaction was monitored by HPLC analysis each 0.5 hour, as described in Example 1.

This resulted in the formation of a mass which gradually became jelly-like, becoming increasingly viscous upon one hour of standing in cold state. After approximately 2 hours, galactose conversion reached greater than 95% and the reaction was terminated by slowly adding carbonic acid until the pH was below 7. In this process, the precipitate dissolved to release tagatose and calcium carbonate precipitated. The calcium carbonate solids were separated from the reaction mixture by filter press.

The analysis of the solution showed that 2772 g of galactose had been consumed and 2550 g of tagatose had been produced with a conversion of 100% and a yield of 92%. The calcium hydroxide slurry converted 554 g/L galactose to 510 g/L tagatose within 2 hours, the tagatose productivity with alkaline isomerization in suspension was 255 g/L·h.

### Example 5

### Product Identity

The identity of the tagatose manufactured according to the present invention was achieved via reference standard sugars by a Waters HPLC system together with a Waters 2414 differential refractometer on a Ca²⁺-form Aminex HPX-87C column (Bio-Rad) using the conditions described in the Method of Assay.

Sugars used as reference standards were lactose, glucose, galactose and tagatose and were of the best commercial grade from Sigma.

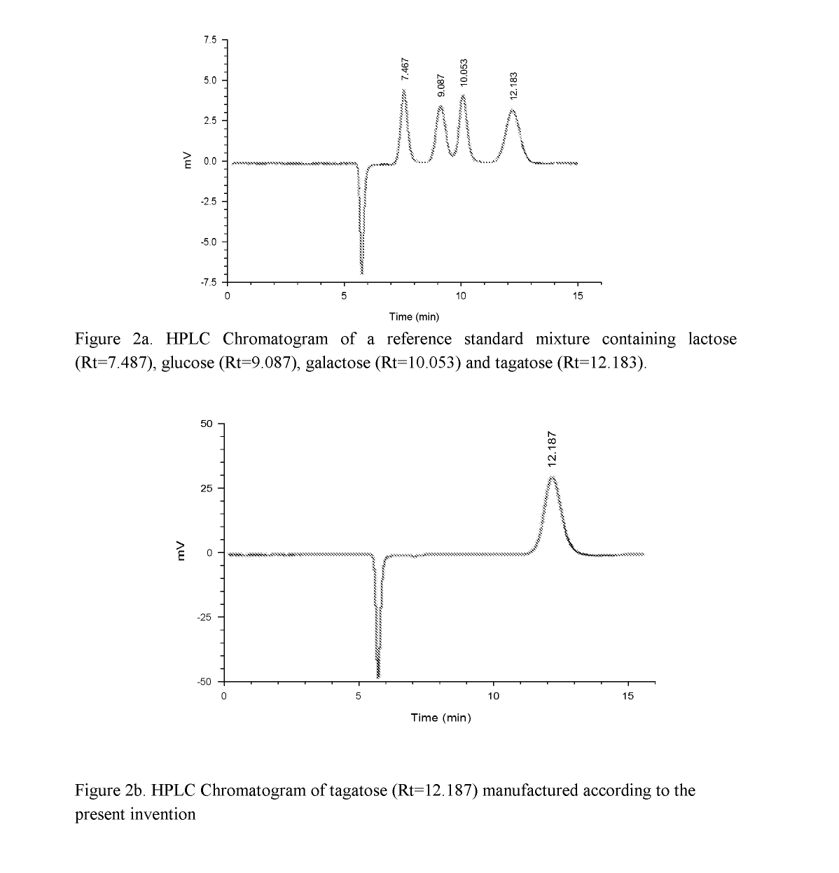

HPLC elution profiles of a reference standard mixture containing lactose, glucose, galactose and tagatose and of three representative batches of tagatose products are shown in FIG. 2. The retention time for the chromatogram of the tagatose product corresponds to that for tagatose in the chromatogram of reference standard mixture. Results of HPLC data confirming the identity of the tagatose manufactured according to the present invention are identical to the commercial tagatose in the reference standard mixture.

Although the invention has been described with preferred embodiments, it is to be understood that variations and modifications may be resorted to as will be apparent to those skilled in the art. Such variations and modifications are to be considered within the purview and the scope of the claims appended hereto.

### REFERENCES CITED

1. Prenosil J E., Stuker E., and Bourne J R. 1987. Formation of oligosaccharides during enzymatic lactose: Part I: State of Art. Biotechnol Bioeng. 30:1019-25.

2. Tanase T., Takei T., Hidai M., and Yano S. 2001. Substrate-dependent chemoselective aldose-aldose and aldose-ketose isomerization of carbohydrates promoted by a combination of calcium ion and monoamines. Carbohydr Res. 333:303-12.

3. Ekeberg, D., Morgenlie, S., and Stenstrom, Y. 2002. Base catalyzed isomerisation of aldoses of the arabino and lyxo series in the presence of aluminate. Carbohydr Res. 337:779-86.

4. Splechtna B., Nguyen T H., Steinböck M., Kulbe K D., Lorenz W., and Haltrich D. 2006. Production of prebiotic galacto-oligosacchrides from lactose using β-galactosidases from Lactobacillus reuteri. J Agric Food Chem. 54: 4999-5006.

5. Alejandra C., Nieves C., Mar V., and Agustin O. 2008. Isomerization of lactose-derived oligosaccnarides: A case study using sodium aluminate. J Agric Food Chem. 56:10954-9.

6. Beadle J R., Saunders, J P., and Wajda T J. 1991. Process for manufacturing tagatose. U.S. Pat. No. 5,002,612.

7. Beadle J R., Saunders J P., and Wajda T J. 1992.Process for manufacturing tagatose. U.S. Pat. No. 5,078,796.

8. Ibrahim O O., and Spradlin J E. 2000. Process for manufacturing D-tagatose. U.S. Pat. No. 6,057,135.

9. Bertelsen H., Eriknauer K., Bottcher K., Christensen H J S., Stougaard P., Hansen O C., and Jorgensen F. 2006. Manufacturing of tagatose. U.S. Pat. No. 6,991,923.

10. Kim S B., Park S W., Song S H., Lee K P., Oh D K., Lim B C., and Kim H J. 2009. Manufacturing method of tagatose using galactose isomerization of high yield. U.S. Patent Application 20090306366.

1. (canceled)

2. A process for manufacturing tagatose, comprising the step: c) reaction of an aqueous suspension of galactose under the presence of metal ions and alkaline condition to convert galactose into tagatose, wherein step c) is carried out by adding an aqueous slurry of metal hydroxide into an aqueous suspension of galactose.

3. The process according to claim 2 further comprises, before the step c), the following steps: a) hydrolysis of lactose with mineral acid in an aqueous solution to convert lactose to galactose and glucose; b) separation of the galactose and glucose from the hydrolyzate obtained in step a).

4. The process according to claim 2, wherein said suspension in step c) has a galactose content of more than 30% by weight.

5. The process according to claim 2, wherein said step c) is performed at 0-30° C.

6. The process according to claim 2, wherein said step c) is performed with a molar ratio of metal hydroxide to galactose of 0.5:1-2:1.

7. The process according to claim 3, wherein said step a) is performed with 0.02-0.6 M mineral acid.

8. The process according to claim 3, wherein said step a) is performed under 90-120° C.

9. The process according to claim 3, wherein the content of lactose in said step a) is more than 30% by weight.

10. The process according to claim 3, wherein said step b) is performed by chromatographic separation.

11. The process according to claim 10, wherein water is used as eluent during the chromatographic separation.

12. The process according to claim 3, wherein said mineral acid is one or more selected from the group consisting of carbonic acid, hydrochloric acid, phosphoric acid and sulfuric acid.

13. The process according to claim 2, wherein said metal hydroxide is one or more selected from the group consisting of aluminum hydroxide, barium hydroxide, calcium hydroxide, magnesium hydroxide, and strontium hydroxide.
